(19) United States
(12) Patent Application Publication
(10) Pub. No.: US 2023/0081591 A1
(43) Pub. Date: Mar. 16, 2023

(54) NOTCH ANTENNA ARRAY

(71) Applicant: SAAB AB, Linköping (SE)

(72) Inventors: Bengt SVENSSON, Mölndal (SE); Sigrid HAMMARQVIST, Linköping (SE)

(21) Appl. No.: 17/799,696

(22) PCT Filed: Feb. 19, 2020
(86) PCT No.: PCT/SE2020/050190

§ 371 Date: Aug. 15, 2022

(51) Int. Cl. H01Q 21/06; H01Q 1/27; H01Q 21/24; H01Q 21/30

(52) U.S. Cl. CPC H01Q 21/064; H01Q 1/27; H01Q 21/24; H01Q 21/30

(57) ABSTRACT

An antenna array is provided. The antenna array includes a plurality of M row antenna structures, each row antenna structure forming a row in the antenna array, M being a positive integer≥2, and a plurality of N column antenna structures, each column antenna structure forming a column in the antenna array, N being a positive integer≥2. Each row antenna structure includes a plurality of row antenna elements, where each row antenna element includes a main body tapering from a bottom portion to a tip portion. The bottom portion of each row antenna element includes a first leg portion having a first feed arrangement, and wherein each row antenna element is joined to at least one adjacent row antenna element so to form a conjoined row of notch antennas.

### TECHNICAL FIELD

The present disclosure relates to notch antennas (may also be known as tapered slot antennas). In particular the present disclosure relates to an antenna array having an interleaved dual polarized array structure.

### BACKGROUND

An antenna may be understood as the interface between radio waves propagating through space and electric currents moving in metal conductors, used with a transmitter or receiver. They are an essential component in any situation where radio waves are essential for operation such as e.g. in radio applications, radar applications, wireless networking, RFID tags, etc.

An antenna array is an antenna having a plurality of connected antennas that work together as a single antenna in order to transmit or receive radio waves. The individual antennas (often referred to as elements) are conventionally connected to a single receiver or transmitter by feedlines that provide power to the antenna elements according to a specific phase relationship. Antenna arrays are preferable since they are capable of achieving higher gain than what can be achieved by a single antenna element.

Further, antenna arrays are used for various applications, and in particular Vivaldi antenna arrays or other tapered notch arrays are used for broadband applications. The Vivaldi or tapered notch antenna elements are generally made by etching a printed pattern on a dielectric substrate. The term “notch” antenna element includes tapered and flared elements in the context of the present disclosure.

The Vivaldi or tapered notch antennas typically have a radiating part starting with a slotline which widens in one direction in a tapered notch. The slotline is typically fed from a transmission line, coaxial line, microstrip or stripline, at the most narrow point, either by direct, electrical contact or by means of an essential quarter wave stub. Below the feed point, the slotline must constitute an open circuit in order to avoid short circuiting the feed. This can be accomplished either by another quarter wave slotline stub, which transforms a short circuit to an open end at the feed, or, which is more common for broadband applications, a cavity which is large enough to act as an open circuit at the feed point.

The tapered notch antenna elements may be used in pairs arranged in essentially orthogonal directions to act as dual polarized antenna elements to transmit and receive signals with either linear polarizations or a combination of them. Further, they are often used in an array structure in order to e.g. achieve Multiple Input Multiple Output (MIMO) capability, transmitting and receiving on different amplitudes or using them in a phased antenna array with electrically scanned beams to supress undesired directions and enhance the desired ones in order to form a directed antenna. Many modern applications will also require every single element to be connected to electronic circuits such as e.g. transmit/receive modules containing amplifiers and phase shifters.

Using Vivaldi or tapered notch elements does have some drawbacks which are especially apparent when mounting a large amount of elements in an array. Printing them on a substrate is a rational process for a one dimensional array and the electronics may also be printed on the same substrate in a so called Brick configuration. However, the total length of the elements and the electronic circuit board will be quite large. Also when combining perpendicular boards to dual polarized antenna arrays, the corners of the ground planes must be electrically connected, which is difficult to perform in a rational manufacturing process.

Using a so called Tile configuration, the electronics are mounted in one or several layers of a circuit board which is perpendicular to the antenna array surface. However, one difficulty is to feed the antenna elements, above the cavity, from a point on the circuit board surface. Typically this is accomplished by means of a coaxial line which will have to be made very small in order not to make the cavity too small. It may also require very small parts and manual mounting and soldering. The connecting of the feed point is a task requiring precision and takes up a non-trivial part of the manufacturing process. Further, it may be difficult to achieve satisfactory fail rates of such antenna elements as the feed point may be very sensitive to faults.

Thus, there is a need for improvements in the art, and in particular for improvements in terms of manufacturing, assembly, and costs.

### SUMMARY

It is therefore an object of the present disclosure to provide an antenna array, and a vehicle having such an antenna array which alleviates all or at least some of the drawbacks associated with the systems discussed in the foregoing.

In particular it is an object of the present disclosure to provide an antenna array, and a vehicle having such an antenna array which provides a less complicated manufacturing and assembly process and alleviates the need for having a separate ground plane.

These objects are achieved by means of an antenna array, and a vehicle having such an antenna array as defined in the appended claims. The term exemplary is in the present context to be understood as serving as an instance, example or illustration.

According to a first aspect of the present disclosure, there is provided an antenna array comprising a plurality M of row antenna structures, each row antenna structure forming a row in the antenna array, M being a positive integer 2, and a plurality N of column antenna structures, each column antenna structure forming a column in the antenna array, N being a positive integer 2. Each row antenna structure comprises a plurality of row antenna elements, where each row antenna element comprises a main body tapering from a bottom portion to a tip portion. The bottom portion of each row antenna element comprises a first leg portion having a first feed arrangement, and wherein each row antenna element is joined to at least one adjacent row antenna element so to form a conjoined row of notch antennas. Moreover, each row antenna element comprises a first recess extending into the main body from the tip portion towards the bottom portion. Each column antenna structure comprises a plurality of column antenna elements, where each column antenna element comprises a main body tapering from a bottom portion to a tip portion. The bottom portion of each column antenna element comprises a second leg portion having a feed arrangement, and wherein each column antenna element is joined to at least one adjacent column antenna element so to form a conjoined column of notch antennas. Moreover, each column antenna element comprises a second recess extending into the main body from the bottom portion towards the tip portion. Furthermore, each first recess is configured to receive a second recess in order to form the antenna array from said M row antenna structures and said N column antenna structures. The antenna array takes to form of an interleaved notch antenna array where each row and each column can be manufactured as one integral structure and form a self-supporting dual polarized array without a need for a supporting ground plane. Moreover, the feed point arranged at the bottom portion of the antenna elements allows for simplified feeding structures. Thus, the need for complicated feed arrangements for the antenna array, which would increase complexity and add manufacturing costs, is alleviated.

The term tapering is in the context of the present disclosure considered to encompass both continuous tapering and stepwise tapering.

Moreover, the row antenna elements may be arranged for emitting/receiving signals of a first polarization, and the column antenna elements for emitting/receiving signals of a second polarization. The first and second polarizations may for example be orthogonal to each other.

In accordance with an exemplary embodiment of the present disclosure, each feed arrangement comprises a connector integrated with the leg portion. In other words, each first feed arrangement and each second feed arrangement comprises a connector integrated with the leg portion. The connector may be a coaxial connector forming a feed point. The connection at the feed point may be realized by soldering or gluing (using conductive glue) the centre pin of the coaxial connector to the main body or by using a fastening screw or a clamp. Alternatively, one can realize the feed by using an open ended transmission line a quarter wavelength away from the feed point, or by utilizing capacitive coupling.

Further, in accordance with another exemplary embodiment of the present disclosure, each row antenna structure forms an integral structure, and each column antenna structure forms an integral structure. In other words, each row and column may be manufactured in a single piece thereby facilitating the subsequent assembly process of the array. Moreover, each integral structure may be a metallic structure. By having an all-metal structure, power losses may be reduced. Moreover, the metallic structure allows for use of simple and cost effective manufacturing processes such as milling, casting, extrusion, laser cutting, or water jet cutting.

Still further, in accordance with yet another exemplary embodiment of the present disclosure, only the bottom portion of each row antenna element is joined to the bottom portion of at least one adjacent row antenna element, and only the bottom portion of each column antenna element is joined to the bottom portion of at least one adjacent column antenna element. In other words, the row antenna elements and column antenna elements are conjoined at their respective bottom portions in order to form the columns and rows of the array. More specifically, the conjoined bottom portions will then act as a foundation to support the array structure when the rows and columns are interleaved, and thereby alleviate the need for a separate ground plate to support the antenna elements.

Yet further, in accordance with an exemplary embodiment of the present disclosure, the antenna array has an operating frequency band, the operating frequency band having a minimum frequency and a maximum frequency, and wherein a distance between each row of notch antenna elements and each column of notch antenna elements is below or equal to half of a wavelength of the maximum frequency. Accordingly, cut-off between adjacent rows and columns is achieved, whereby the need for having a separate ground plane in the antenna array is alleviated. By omitting the ground plate the overall weight of the antenna array is reduced. Moreover, any complex and tedious manufacturing process steps related to the ground plane (e.g. copper taping corners) are eliminated.

According to yet another exemplary embodiment of the present disclosure, the main body of each row antenna element has a first (circumferentially enclosed) cavity at an interior portion, and wherein the main body of each column element has a second (circumferentially enclosed) cavity at an interior portion. The first and second cavities may be understood as that the “interior” of the main body of each antenna element is at least partly removed. In other words, the first and second cavities form circumferentially enclosed cavities within the main body of each antenna element. This is in contrast to the first and second recesses which instead may be understood as “open” cavities. By removing portions of the interior of the main body of the antenna elements the overall weight of the antenna array is effectively reduced, which is particularly advantageous in for example airborne applications.

According to a second aspect of the present disclosure there is provided a vehicle comprising an antenna array according to any one of the embodiments disclosed herein. With this aspect of the disclosure, similar advantages and preferred features are present as in the previously discussed first aspect of the disclosure. A vehicle may in the present context be a surface vehicle (truck, bus, car, tank, etc.), a vessel (i.e. a ship), or an aircraft.

Further embodiments of the disclosure are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the present disclosure will in the following be further clarified with reference to the embodiments described hereinafter.

### BRIEF DESCRIPTION OF THE DRAWINGS

FIG. 1a is a perspective view illustration of a row antenna structure comprising a plurality of row antenna elements in accordance with an embodiment of the present disclosure.

FIG. 1b is a perspective view illustration of a column antenna structure comprising a plurality of column antenna elements in accordance with an embodiment of the present disclosure.

FIG. 2 is a perspective view illustration of an antenna array in accordance with an embodiment of the present disclosure.

FIG. 3 is a partly exploded perspective view of an antenna array in accordance with an embodiment of the present disclosure.

FIG. 4 is an enlarged perspective view of a bottom portion of a main body of a column antenna element in accordance with an embodiment of the present disclosure.

### DETAILED DESCRIPTION

In the following detailed description, preferred embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

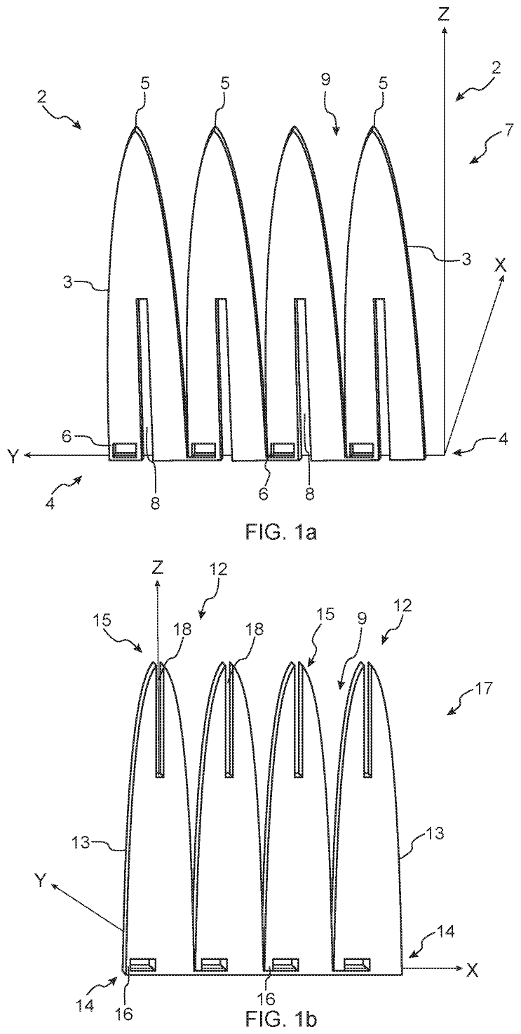

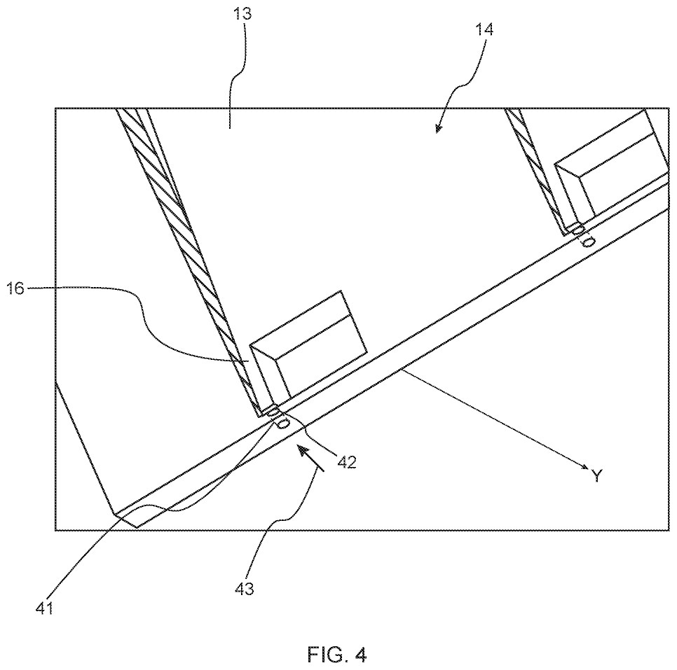

FIG. 1a is a perspective view illustration of a row antenna structure 7 according to an embodiment of the present disclosure. The row antenna structure 7 has a plurality of row antenna elements 2, more precisely, the row antenna structure 7 has four row antenna elements (may also be referred to as row elements). Each row antenna element comprises a main body 3 tapering from a bottom portion 4 to a tip portion 5. The bottom portion comprises a first leg portion having a first feed arrangement. Details related to the feed arrangement will be further discussed in reference to FIG. 4. Moreover, each row antenna element is joined to at least one adjacent row antenna element 2 so to form a conjoined row of notch antennas 7. The row antenna elements 2 are joined together only at the bottom portion 4 of the main bodies 3. The row antenna structure 7 thereby forms an integral structure which can be manufactured in one piece by for example extrusion, casting, moulding, 3D-printing, or milling. Moreover, since the row antenna structure 7 is an independent structure cutting methods such as laser or water jet cutting may additionally be used. The row antenna structure 7 may be manufactured from metal or a metallized plastic.

It should be noted that even though the term “antenna element” is used, FIG. 1a shows three notch antenna elements since one notch antenna element is formed from the halves of two adjacent main bodies 3. Accordingly, the term “antenna element” does not necessarily imply an antenna functionality but merely that it is an element of an antenna, and in the present context an element of an antenna array. Thus, the terminology “antenna element” is mainly used for readability of the present disclosure and should therefore not be construed as limiting to the present disclosure.

Further, each row antenna element 2, or more precisely, each main body 3 of each row antenna element 2 has a first recess 8 extending into the main body 3 from the bottom portion 4 towards the tip portion 5. Stated differently, the bottom portion 4 of each row antenna element 2 has a first slit 8 extending into the main body 3 towards the tip portion 5. Moreover, the row antenna structure 7 is not arranged on a substrate, but is a stand-alone structure. Thus, each row antenna element 2 has a (pre)defined thickness (i.e. an extension in the X-direction).

The dimensions of each row antenna element (row element) 2 is subject to variations depending the intended operational frequency band of the antenna. However, in general the “width” of each row antenna element (i.e. extension along the Y-direction) is approximately λ/2, the length of each row antenna element (i.e. extension along the Z-direction) is selected depending on the bandwidth. The length may for example be in the range from λ/3 to several λ. The thickness of each row antenna element varies by required impedance, but may for example be less than λ/10. Moreover, the dimensions of each antenna element 2, 12 need not be uniform across the entire array but may vary among individual elements or individual rows/columns within an array. Here, λ represents the wavelength of the highest frequency of the operational frequency band of the antenna.

FIG. 1b is a perspective view of a column antenna structure 17 in accordance with an embodiment of the present disclosure. The column antenna structure 7 has a plurality of column antenna elements 12, more specifically, the column antenna structure has four column antenna elements 12 (may also be referred to as column elements). Each column antenna element 12 comprises a main body 13 tapering from a bottom portion 14 to a tip portion 15. Furthermore, the bottom portion 14 has a second leg portion 16 having a feed arrangement. Moreover, analogous to the row antenna elements 2, each column antenna element 12 is joined to one or more adjacent column antenna elements 12 so to form a conjoined column of notch antennas 17. As for the row antenna elements of FIG. 1a, the column antenna elements 12 are joined together only at the bottom portion 14 of the main bodies 13. The column antenna structure 17 thereby forms an integral structure which can be manufactured in one piece by for example extrusion, casting, moulding, 3D-printing, or milling. Moreover, since the column antenna structure 17 is an independent structure, cutting methods such as laser or water jet cutting may additionally be used. The column antenna structure 17 may be manufactured from metal or a metallized plastic.

As mentioned in reference to FIG. 1a, it should be noted that even though the term “antenna element” is used, FIG. 1b shows three notch antenna elements since one notch antenna element is formed from the halves of two adjacent main bodies 3. Accordingly, the term “antenna element” does not necessarily imply an antenna functionality but merely that it is an element of an antenna, and in the present context an element of an antenna array. Thus, the terminology “antenna element” is mainly used for readability of the present disclosure and should therefore not be construed as limiting to the present disclosure.

Furthermore, each column antenna element 12 comprises a second recess 18 extending into the main body 13 from the tip portion 15 towards the bottom portion 14. In other words, the top portion 15 of each column antenna element has a first slit 18 extending into the main body 13 towards the bottom portion 14. Moreover, the column antenna structure 17 is not arranged on a substrate, but is a stand-alone structure. Thus, each column antenna element 12 has a (pre)defined thickness (i.e. an extension in the Y-direction).

The dimensions of each column antenna element (column element) 12 is subject to variations depending the intended operational frequency band of the antenna. However, in general the “width” of each row antenna element (i.e. extension along the Y-direction) is approximately λ/2, the length of each row antenna element (i.e. extension along the Z-direction) is selected depending on the bandwidth. The length may for example be in the range from λ/3 to several λ. The thickness of each column antenna element 12 varies by required impedance, but may for example be less than λ/10. Moreover, the dimension need not be uniform across the entire array but may vary among individual elements within an array. Here, λ represents the wavelength of the highest frequency of the operational frequency band of the antenna.

Each row antenna element 2 and each column antenna element 12 further comprises a rectangular cavity adjacent to the first and second leg portions 6, 16, respectively. While the cavity is of a rectangular shape, a plurality of shapes are possible (circular, elliptical, polygonal, etc.) for the cavity as long as the shape of the cavity confers electromagnetic wave properties of the notch antenna so to allow for operation of the notch antenna.

Moreover, two adjacent main bodies 3, 13 of either one of the row antenna elements or column antenna elements form a tapering gap 9 between each other, the tapering gap tapers in a direction from the tip 5 portion towards the bottom portion 4 (i.e. in a negative Z-direction), so to form a notch antenna element. Thus, in FIG. 1a, three (row) notch antenna elements are depicted, and in FIG. 1b three (column) notch antenna elements are depicted. As readily understood by the skilled reader, a notch antenna element comprises one half of each of two adjacent row/column antenna elements 2, 12.

In more detail, each notch antenna element can be said to comprise an electrically conductive body having a tapering slot 9. The slot separates the notch antenna element into two projections or prongs (each projection being one half of one main body 3, 13). Accordingly, one of the “projections” may be grounded while the other projection is energized by a RF signal (via the leg portions 6, 16). Even though the illustrated examples show continuously tapering gaps 9, in other embodiments the gaps 9 are stepwise tapering gaps (9). In other words, the main bodies 3, 13 may be tapering from the bottom portion 4, 14 to the tip portion 5, 15 in a stepwise manner. Stepwise tapering may provide simplified manufacturing but with reduced bandwidth properties.

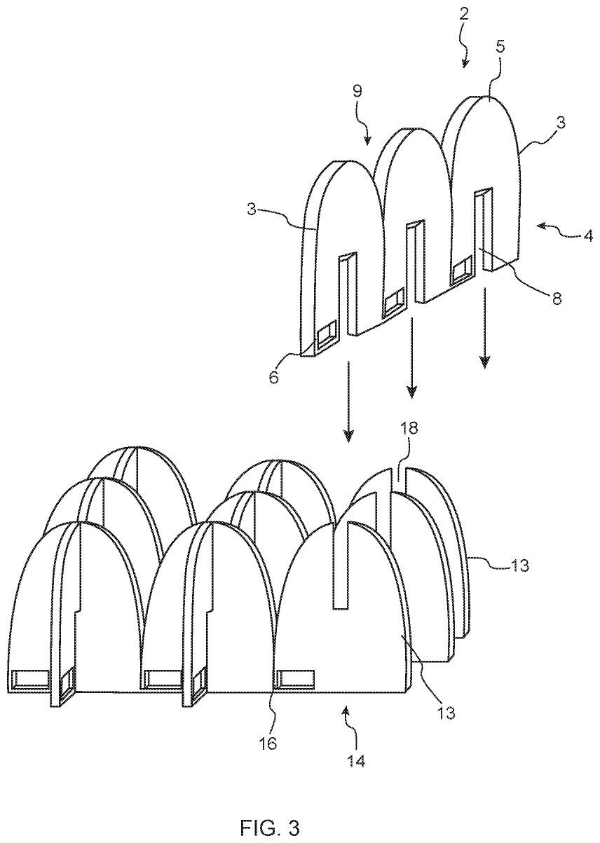

Each first recess 8 is configured to receive one of the second recesses 18 in order to form an antenna array. More specifically, the each first recess 8 is arranged to mate with a corresponding second recess 18 so to form the antenna array. This “mating” or assembly process will be further elucidated in reference to FIG. 3.

Furthermore, the main body 3, 13 of each row antenna element 2 and each column antenna element 12 may have a circumferentially enclosed cavity (or pocket) at an interior portion (not shown). In other words, parts of the interior of the antenna elements 2, 12 may be removed without adverse operational effects in order to reduce the overall weight of the antenna array. Preferably the interior portion of an upper portion (e.g. upper half) of the row antenna elements 2 is removed, while the interior portion of a lower portion (e.g. lower half) of the column antenna elements 12 is removed. The term circumferentially enclosed cavity is to be interpreted as that an arbitrarily shaped hole is formed in the main body 3 of the antenna element. This is in contrast to the recesses 8, 18 and the cavities proximate to the leg portions 6, 16 which are open to the surrounding space (even if the cavities proximate to the leg portions 6, 16 barely open, see e.g. FIG. 4, it is still considered as a circumferentially open cavity). For example, looking at the recesses 8 of the row antenna elements 2 they are circumferentially open via a bottom surface of the bottom portion 4.

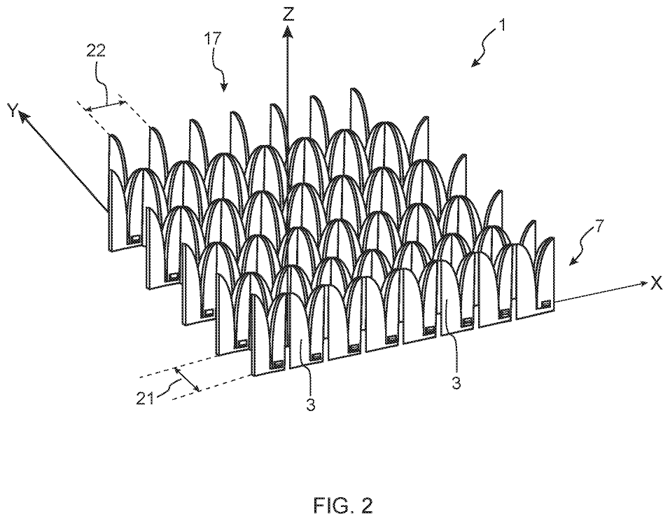

FIG. 2 is a perspective view of an assembled antenna array 1 formed by five row antenna structures and seven column antenna structures. The antenna array 1 forms a 5×8 dual polarized notch antenna array. The first recess of each row antenna element has mated with a second recess of a corresponding column antenna element. Accordingly, each row antenna structure 7 has an extension along a first direction (X-direction), and each column antenna structure 17 has an extension along a second direction (Y) direction. The first and second directions are perpendicular to each other. In other words, the antenna array 1 has a plurality of row antenna structures 7 forming rows of notch antenna elements along the first direction (X-direction), and a plurality of column antenna structures 17 forming columns of notch antenna elements along the second direction (Y-direction). The rows of notch antenna elements may have a first polarization while the columns of notch antenna elements may have a second polarization that is (substantially) orthogonal to the first polarization. This will form a dual, linear polarized array 1. In the present context the term “perpendicular” need not necessarily be perfectly perpendicular but may deviate within a normal tolerance threshold. Accordingly, the first and second directions may have an extension within the range of 85 to 95 degrees relative to each other.

The antenna array 1 is configured to operate within a frequency band, i.e. the antenna array 1 has an operating frequency band. In some embodiments, the operating frequency band has a minimum frequency and a maximum frequency (i.e. a lower frequency limit and an upper frequency limit). The antenna array 1 is preferably arranged such that a distance 21 between each row antenna structure 7 and a distance 22 between each column antenna structure 17 is below half of a wavelength of the maximum frequency (i.e. upper frequency limit). However, in some embodiments the row antenna structures 7 may operate at a first frequency band while the column antenna structures 17 may operate at a second frequency band different from the first frequency band. Thus, the distances 22 between each column antenna structure 17 may be different from the distances 21 between each row antenna structure 7.

FIG. 3 is a partly exploded perspective view of an antenna array according to an exemplary embodiment of the present disclosure. In more detail, FIG. 3 serves to illustrate an assembly step and more specifically how the row antenna structures are interleaved with the column antenna structure so to form the self-supporting interleaved antenna array. The separated row antenna structure having three row antenna elements 2 is to be placed on right-most column antenna elements of the three column antenna structures such that the recesses 8 of the row antenna elements 2 mate with the recesses 18 of the column antenna structures as indicated by the downward pointing arrows. Naturally, the row antenna structures and column antenna structures may further comprise one half of a main body 3, 13 on each side so to form a 4×4 notch antenna array when assembled. However, these half portions arranged on either side of each row and column were omitted in FIG. 3 in order to more clearly elucidate the interleaving assembly process. In some embodiments, the top portion of the recess 18 of the column antenna structures is smaller or equal to the thickness of the main body 3 of the row antenna elements 3. This is in order to ensure a tight fit and good galvanic coupling at the top of each antenna element, thereby improving the electrical properties of the antenna array. However, the galvanic coupling (may also be referred to as electrical contact) may be accomplished by means of electrically conductive bonding (by means of an electrically conductive adhesive, soldering, or the like). Thus, in some embodiments, the second recess of each column antenna element further comprises an electrically conductive bonding on at least a top portion of the second recess so to provide electrical coupling between the tip portions of the column antenna elements and the row antenna elements when antenna array is assembled. Stated differently, the antenna array may further comprise an electrically conductive bonding (layer) between the tip portions of the column antenna elements and the row antenna elements.

Moreover, since the row antenna structures and column antenna structures generally form “2D” structures, which can be made from one single piece of metal, manufacturing cost and complexity may be reduced.

FIG. 4 is an enlarged perspective view of a feed arrangement 41 of a notch antenna element. Even though a feed arrangement 41 of a column (notch) antenna element 12 is illustrated, the same features and advantages are readily present on the row (notch) antenna elements. In other words, the following discussion applies to the feed arrangement of the column antenna elements and the feed arrangement of the row antenna elements.

The feed arrangement 41 comprises a feed point 42, which is the electrical point that feeds the RF waves (indicated by arrow 43) to the antenna element when transmitting or receiving the incoming RF waves incoming to the antenna element. Moreover, the feed arrangement 41 may comprise a connector (e.g. a coaxial connector) integrated with the leg portion 16. The coaxial connector may be realized by attaching a connector centre pin by means of soldering, using conductive glue, or using a fastening screw or clamp, to the feed point. Alternatively, one can use an open ended transmission lane approximately a quarter wavelength away from the feed point 42, or use a capacitive coupling arrangement. By integrating the connectors with the leg portion the need for complicated feed arrangements is alleviated, thereby reducing complexity and manufacturing costs.

Thus, in some embodiments the feed arrangement 41 comprises a centre pin extending from the leg portion 16 and through the bottom plate/surface of the bottom portion (via which each individual element is conjoined). The centre pin is preferably fixed or integrated to the leg portion 16 and extends through the bottom plate so to enable for direct contact with an underlying substrate. Thereby the substrate's (i.e. circuit board's) corresponding feeding arrangements may be directly connected to the feed arrangements of the antenna array, simplifying assembly and manufacturing.

It is to be understood that the present invention is not limited to the embodiments described above and illustrated in the drawings; rather, the skilled person will recognize that many changes and modifications may be made within the scope of the appended claims. Thus, variations to the disclosed embodiments can be understood and effected by the skilled addressee in practicing the claimed disclosure, from a study of the drawings, the disclosure, and the appended claims. Furthermore, in the claims, the word “comprising” does not exclude other elements or steps, and the indefinite article “a” or “an” does not exclude a plurality.

1. An antenna array comprising:
a plurality of M row antenna structures, each row antenna structure forming a row in the antenna array, M being a positive integer≥2, and each row antenna structure comprising:
a plurality of row antenna elements, each row antenna element comprising a main body tapering from a bottom portion to a tip portion, the bottom portion comprising a first leg portion having a first feed arrangement, and wherein each row antenna element is joined to at least one adjacent row antenna element so to form a conjoined row of notch antennas; and
wherein each row antenna element comprises a first recess extending into the main body from the bottom portion towards the tip portion;
a plurality of N column antenna structures, each column antenna structure forming a column in the antenna array, N being a positive integer≥2, and each column antenna structure comprising:
a plurality of column antenna elements, each column antenna element comprising a main body tapering from a bottom portion to a tip portion, the bottom portion comprising a second leg portion having a second feed arrangement, and wherein each column antenna element is joined to at least one adjacent column antenna element so to form a conjoined column of notch antennas; and
wherein each column antenna element comprises a second recess extending into the main body from the tip portion towards the bottom portion;
wherein each first recess is configured to receive a second recess in order to form the antenna array from the M row antenna structures and the N column antenna structures.

2. The antenna array according to claim 1, wherein each feed arrangement comprises a connector integrated with the leg portion.

3. The antenna array according to claim 2, wherein each feed arrangement comprises a centre pin extending from the leg portion through an opening in a bottom surface of each row antenna element and each column antenna element.

4. The antenna array according to claim 1, wherein each row antenna structure forms an integral structure; and
wherein each column antenna structure forms an integral structure.

5. The antenna array according to claim 4, wherein each integral structure is a metal structure.

6. The antenna array according to claim 1, wherein only the bottom portion of each row antenna element is joined to the bottom portion of at least one adjacent row antenna element; and
wherein only the bottom portion of each column antenna element is joined to the bottom portion of at least one adjacent column antenna element.

7. The antenna array according to claim 1, wherein each first recess is configured to receive a second recess in order to form the antenna array such that each row antenna structure has an extension along a first direction, and each column antenna structure has an extension in a second direction perpendicular to the first direction.

8. The antenna array according to claim 1, wherein the antenna array is a dual polarized notch antenna array.

9. The antenna array according to claim 1, wherein the antenna array having an operating frequency band, the operating frequency band having a minimum frequency and a maximum frequency, and wherein a distance between each row antenna structure and each column antenna structure is below half of a wavelength of the maximum frequency.

10. The antenna array according to claim 1, wherein the row antenna structures have a first operating frequency band, and the column antenna structures have a second operating frequency band different from the first operating frequency band.

11. The antenna array according to claim 9, wherein the distance between each row antenna structure is a first distance and the distance between each column antenna structure is a second distance different from the first distance.

12. The antenna array according to claim 1, wherein the main body of each row antenna element has a first cavity at an interior portion; and
wherein the main body of each column element has a second cavity at an interior portion.

13. The antenna array according to claim 1, wherein the antenna array is a self-supporting interleaved antenna array.

14. A vehicle comprising an antenna array according to claim 1.
